(19) United States
(12) Patent Application Publication
(10) Pub. No.: US 2026/0097476 A1
(43) Pub. Date: Apr. 9, 2026

(54) PAIR OF PLIERS WITH A LATCH UNIT

(71) Applicant: JYE LINS CO., LTD., Taichung (TW)

(72) Inventor: Min-Zheng ZENG, Taichung (TW)

(21) Appl. No.: 18/908,828

(22) Filed: Oct. 8, 2024

(51) Int. Cl. B25B 27/20

(52) U.S. Cl. CPC B25B 27/205

(57) ABSTRACT

A pair of pliers includes two handles and a latch unit. The handles are pivotally connected to each other. The latch unit includes a pawl, a rack, a spring and a switch. The pawl is secured to the first handle. The rack is pivotally connected to the second handle. The spring biases the rack into engagement with the pawl. The switch is movable between two positions. In the first position, the switch allows engagement of the rack with the pawl. In the second position, the switch keeps the rack from the pawl.

### BACKGROUND OF INVENTION

### 1. Field of Invention

The present invention relates to a pair of pliers and, more particularly, to a latch unit of a pair of pliers.

### 2. Related Prior Art

U.S. Pat. No. 4,476,750 discloses a conventional pair of pliers including two jaws and two handles. Each of the handles is formed with an end plate. The end plates are pivotally connected to each other by a pin. Accordingly, the handles are pivotable relative to each other. A latching mechanism is arranged between the end plates. The ratchet mechanism includes a rack, a pawl and a spring. The rack is secured to the first end plate. The pawl is pivotally connected to the second end plate by a pivot post. The pawl includes an arm extending beyond the second end plate. The spring is compressed between the pawl and an anchor post secured to the second handle. The spring tends to keep the pawl engaged with the rack.

In a round of operation, the arm is operated to disengage the pawl from the rack to allow the handles to be pivoted from each other. Then, the arm is released to allow the spring to engage the pawl with the rack again. Then, the handles are pivoted toward each other so that the jaws are moved toward or from each other. The spring allows the pawl to rattle on the rack when the handles are pivoted toward each other. The spring keeps the pawl engaged with the rack when the pivoting of the handles toward each other is stopped. Accordingly, the jaws are kept in position. A strong C-ring is kept shrunk or expanded. Now, a user is allowed to move the strong C-ring onto or from an axle for example without having to exert a large squeezing force on the handles. In another round of operation, the above-mentioned process is repeated.

However, the arm must be operated to disengage the pawl from the rack in every round of operation. Hence, this conventional pair of pliers is not convenient when it is used to handle a weak C-ring because the user only has to exert a small squeezing force on the handles to keep the weak C-ring shrunk or expanded while moving the weak C-ring onto or from an axle.

The present invention is therefore intended to obviate or at least alleviate the problems encountered in the prior art.

### SUMMARY OF INVENTION

It is the primary objective of the present invention to provide a pair of pliers with a convenient latch unit.

To achieve the foregoing objective, the latch unit includes a pawl, a rack, a spring and a switch. The pawl is secured to a first handle of the pair of pliers. The rack is pivotally connected to a second handle of the pair of pliers. The handles are pivotally connected to each other. The spring biases the rack into engagement with the pawl. The switch is movable between two positions. In the first position, the switch allows engagement of the rack with the pawl. In the second position, the switch keeps the rack from the pawl.

Other objectives, advantages and features of the present invention will be apparent from the following description referring to the attached drawings.

### BRIEF DESCRIPTION OF DRAWINGS

The present invention will be described in detail with reference to the drawings wherein:

FIG. 1 is a perspective view of a pair of pliers equipped with a latch unit in accordance with the preferred embodiment of the present invention;

FIG. 2 is a cut-away view of the pair of pliers shown in FIG. 1;

FIG. 3 is another cut-away view of the pair of pliers shown in FIG. 1;

FIG. 4 is a cross-sectional view of the pair of pliers shown in FIG. 2;

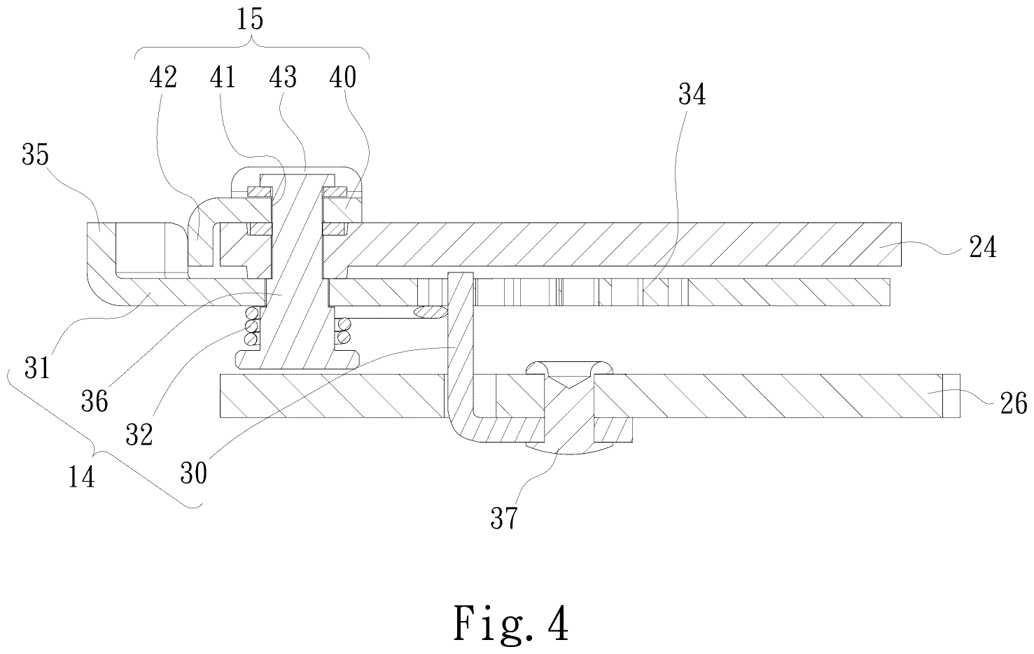

FIG. 5 is a top view of the pair of pliers shown in FIG. 2;

FIG. 6 is a top view of the pair of pliers in another position than shown in FIG. 5; and

FIG. 7 is a top view of the pair of pliers in another position than shown in FIG. 6.

### DETAILED DESCRIPTION OF PREFERRED EMBODIMENT

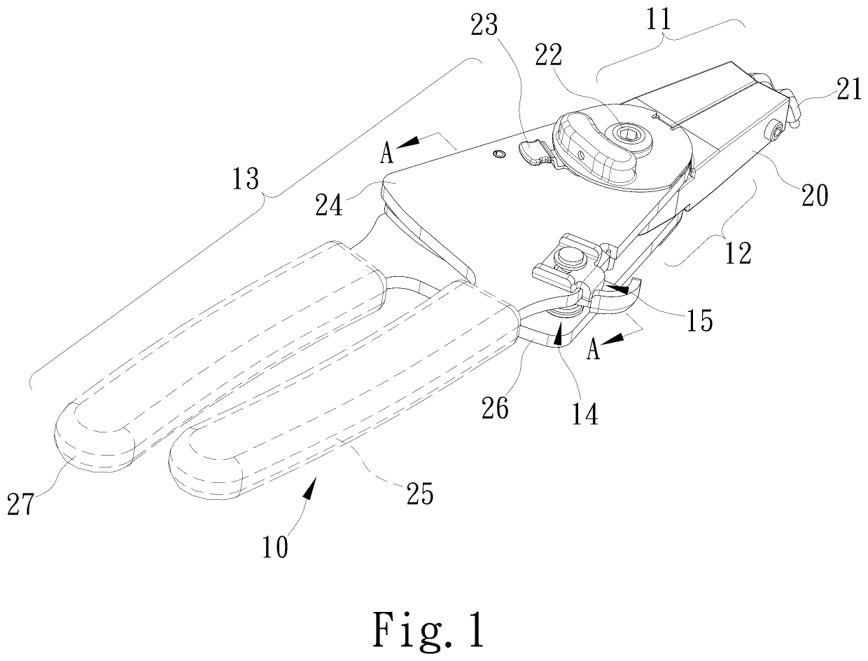

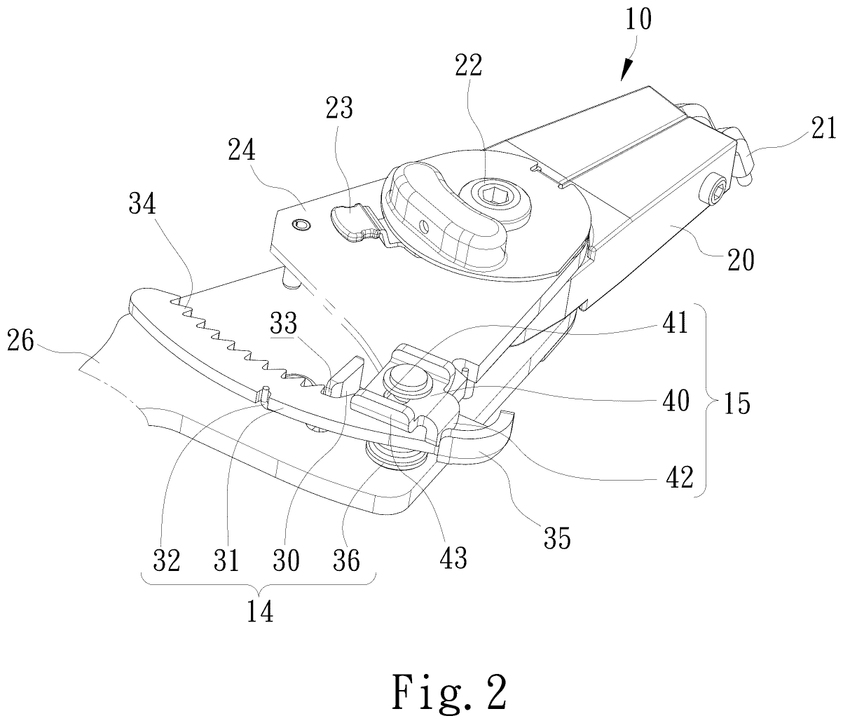

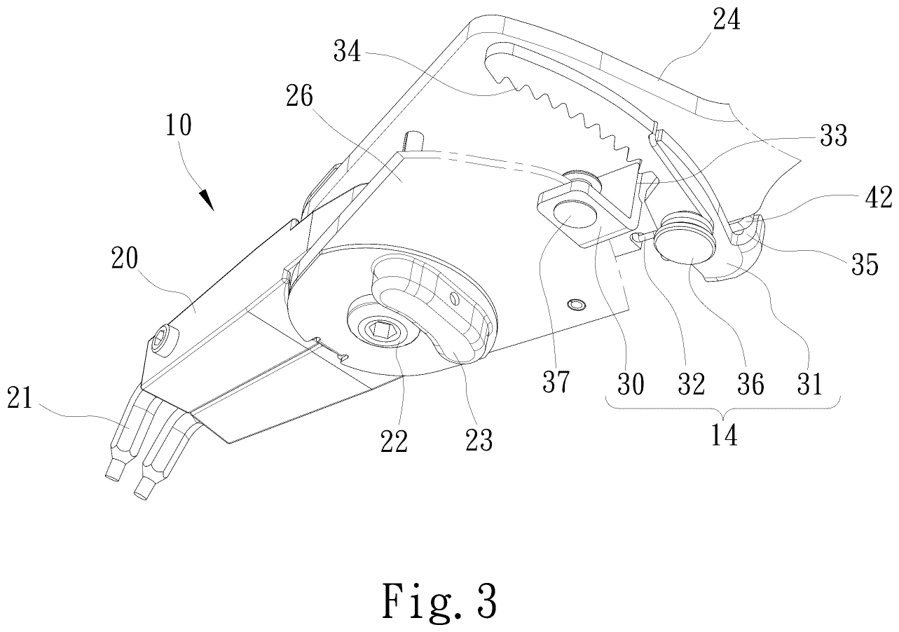

Referring to FIGS. 1 through 3, a pair of pliers 10 includes a head unit 11, a pivotal connection unit 12, a handle unit 13 and a latch unit 14 in accordance with the preferred embodiment of the present invention. The handle unit 13 includes two substantially identical handles 25 and 27. The handle 25 is formed with an end plate 24. The handle 27 is formed with an end plate 26.

The pivotal connection unit 12 includes a pivot 22 for pivotally connecting the end plates 24 and 26 to each other. Thus, the handles 25 and 27 are pivotable toward and from each other.

The head unit 11 includes two identical jaws 20 connected to the end plates 24 and 26. Each of the jaws 20 includes a tip 21 extending from an end. The tips 21 are operable to bring two ends of a C-clip (not shown) toward or from each other.

The pivotal connection unit 12 further includes a switch 23 operable to switch the pair of pliers 10 between two modes. In the first mode, the jaws 20 are pivoted toward each other as the handles 25 and 27 are pivoted toward each other. In the second mode, the jaws 20 are pivoted from each other as the handles 25 and 27 are pivoted toward each other. The switch 23 and related elements for switch the pair of pliers 10 between the modes will not be further described in detail for not being the spirit of the present invention.

The latch unit 14 is arranged between the end plates 24 and 26. The latch unit 14 includes a pawl 30, a rack 31, a torque spring 32, a post 36, a pin 37 and a switch 15. The pawl 30 is formed with a tooth 33. The pin 37 secures the pawl 30 to the end plate 26.

The rack 31 is pivotally connected to the end plate 24 by the post 36. The rack 31 comprises ratchet teeth 34 and a wall 35. The ratchet teeth 34 extend from an edge of the rack 31. The wall 35 extends on a face of the rack 31 along an arch.

The torque spring 32 includes two rectilinear sections extending from a helical section. The helical section of the torque spring 32 extends around the post 36. One of the rectilinear sections of the torque spring 32 is secured to the end plate 24. The remaining one of the rectilinear sections of the torque spring 32 is connected to the rack 31. Thus, the torque spring 32 tends to engage the rack 31 with the pawl 30.

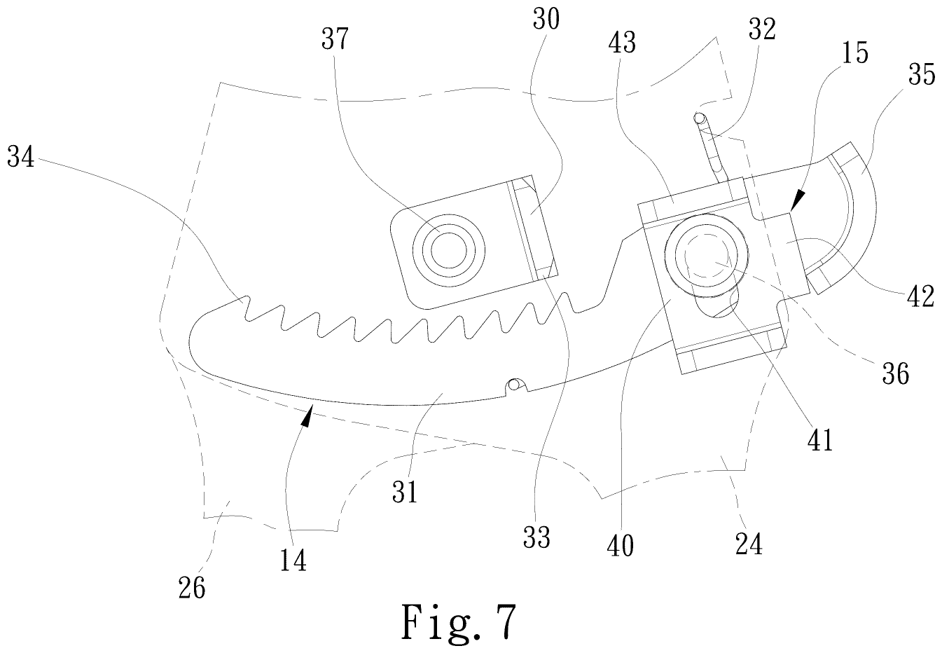

Referring to FIG. 7, the switch 15 is formed with a base 40, a slot 41, a restraint 42 and two tabs 43. The base 40 is substantially a rectangular plate. The slot 41 is cut in the base 40. The restraint 42 perpendicularly extends from an edge of the base 40. Each of the tabs 43 perpendicularly extends from another edge of the base 40. The restraint 42 is located between the tabs 43.

The receives the post 36. The slot 41 extends between the tabs 43. The tabs 43 are operable to move the base 40 relative to the end plate 24, thereby moving the switch 15 between two positions.

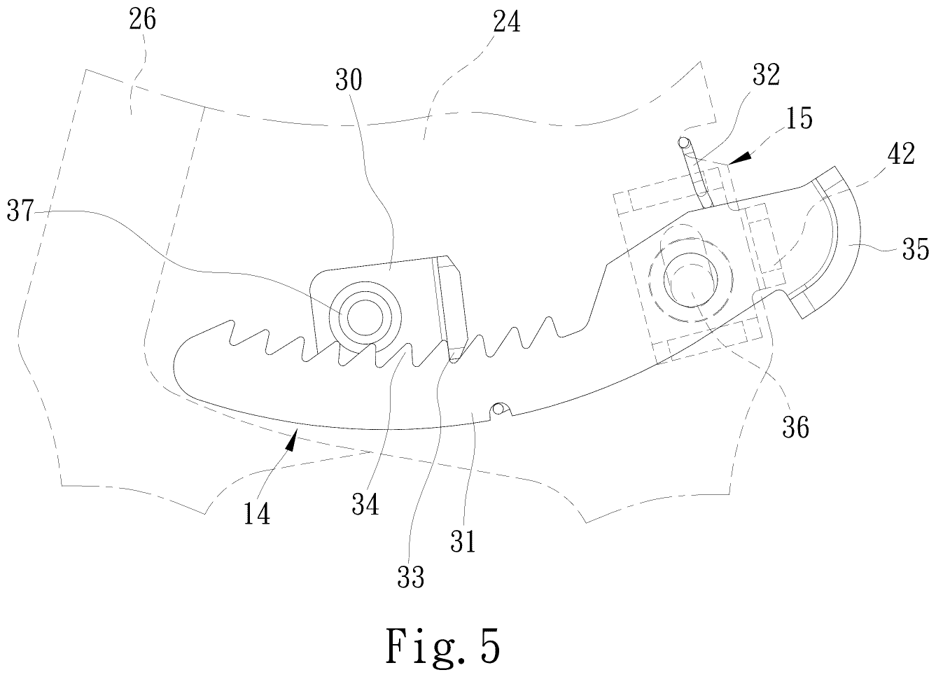

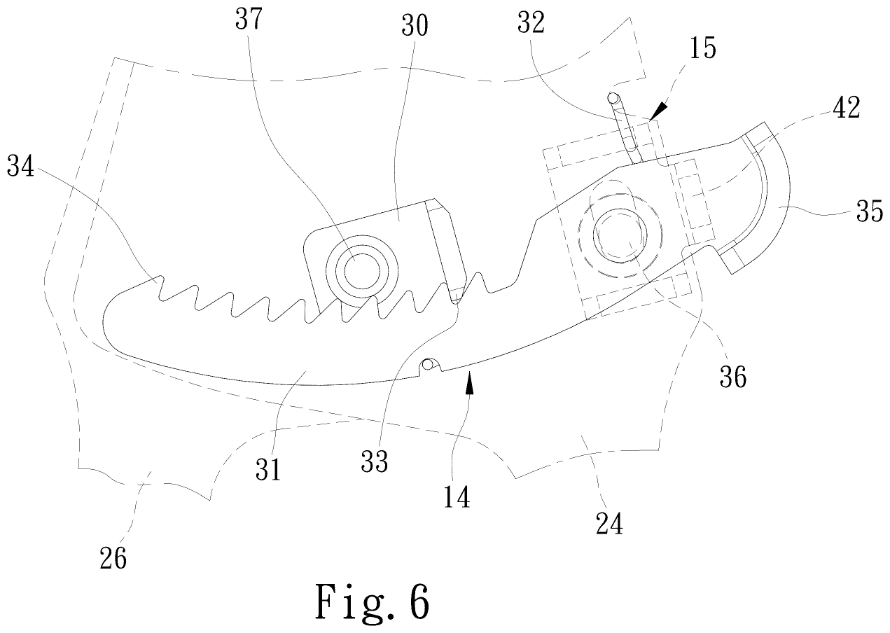

Referring to FIGS. 5 and 6, the switch 15 is in the first position wherein the wall 35 is not aligned with the restraint 42, thereby allowing the torque spring 42 to keep the rack 31 engaged with the pawl 30. Thus, the handles 25 and 27 are allowed to be pivoted toward each other as the rack 31 rattles on the pawl 30. The handles 25 and 27 are not allowed to be pivoted from each other.

Referring to FIG. 7, the switch 15 is in the second position wherein the wall 35 is abutted against the restraint 42, thereby keeping the rack 31 from the pawl 30. Thus, the handles 25 and 27 are allowed to be pivoted toward and from each other.

Advantageously, the switch 15 is movable between the first and second positions. In the first position, the switch 15 allows the latch unit 14 to operate normally so that a user is allowed to pivot the handles 25 and 27 toward each other to expand or shrink a strong C-ring (not shown) and that the user does not have to exert a squeezing force on the handles 25 and 27 to keep the strong C-ring in position. In the second position, the switch 15 disables the latch unit 14 to allow the user to pivot the handles 25 and 27 toward and from each other. Now, the pair of pliers 10 is suitable for handling a weak C-ring (not shown).

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A pair of pliers comprising:
a first handle;
a second handle connected to the first handle; and
a latch unit comprising:
a pawl secured to the first handle;
a rack pivotally connected to the second handle;
a spring for biasing the rack into engagement with the pawl; and
a switch movable between a first position and a second positions,
wherein the switch allows engagement of the rack with the pawl in the first position, wherein the switch keeps the rack from the pawl in the second position.

2. The pair of pliers according to claim 1, wherein the latch unit further comprises a post secured to the second handle, wherein the spring comprises two rectilinear sections and a helical portion formed between the rectilinear sections, wherein the helical portion extends around the post, wherein one of the rectilinear sections is connected to the second handle, wherein the remaining one of the rectilinear sections is connected to the rack.

3. The pair of pliers according to claim 2, wherein the rack is pivotally connected to the second handle by the post.

4. The pair of pliers according to claim 2, wherein the switch is movably connected to the second handle by the post.

5. The pair of pliers according to claim 4, wherein the switch comprises a slot for receiving the post so that the switch is movably connected to the second handle.

6. The pair of pliers according to claim 1, wherein the rack comprises a wall in contact with the switch in the second position.

7. The pair of pliers according to claim 6, wherein the switch comprises a restraint in contact with wall when the switch is in the second position.

8. The pair of pliers according to claim 1, wherein the switch comprises two tabs operable to move the switch.
